(19) United States
(12) Patent Application Publication
(10) Pub. No.: US 2020/0052260 A1
(43) Pub. Date: Feb. 13, 2020

(54) BATTERY MODULE WITH FOIL ARRANGED BETWEEN BATTERY CELLS

(71) Applicant: Tiveni MergeCo Inc., San Mateo, CA (US)

(72) Inventors: Heiner FEES, Bietigheim-Bissingen (DE); Andreas TRACK, Sachsenheim (DE); Ralf MAISCH, Abstatt (DE); Alexander EICHHORN, Eppingen (DE); Jörg DAMASKE, Freiberg (DE); Valentin BROKOP, Walheim (DE); Hans-Joachim PFLÜGER, Wüstenrot (DE); Claus Gerald PFLÜGER, Markgröningen (DE)

(21) Appl. No.: 16/536,170

(22) Filed: Aug. 8, 2019

Related U.S. Application Data
(60) Provisional application No. 62/716,694, filed on Aug. 9, 2018.

(51) Int. Cl. H01M 2/10; B60K 1/04; B60L 50/64; H01M 2/02; H01M 2/04; H01M 2/20; H01M 10/42

(52) U.S. Cl. CPC H01M 2/1077; B60K 1/04; B60L 50/64; H01M 2/022; H01M 2/0237; H01M 2/0262; H01M 2220/20; H01M 2/027; H01M 2/043; H01M 2/046; H01M 2/206; H01M 10/4207; H01M 2/0267

(57) ABSTRACT

In an embodiment, a battery module includes a plurality of battery cells arranged in a plurality of rows and columns, and foil arranged between two or more adjacent battery cells among the plurality of battery cells.

### CROSS-REFERENCE TO RELATED APPLICATIONS

The present application for patent claims the benefit of U.S. Provisional Application No. 62/716,694 with attorney docket no. TIV-180003P1, entitled “BATTERY MODULE WITH FOIL ARRANGED BETWEEN BATTERY CELLS AND METHOD OF ASSEMBLY”, filed Aug. 9, 2018, which is assigned to the assignee hereof and hereby expressly incorporated by reference herein in its entirety.

### BACKGROUND

### 1. Field of the Disclosure

Embodiments relate to a battery module with foil arranged between battery cells.

### 2. Description of the Related Art

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are electrically connected (e.g., in series or in parallel) to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

### SUMMARY

In an embodiment, a battery module includes a plurality of battery cells arranged in a plurality of rows and columns, and foil arranged between two or more adjacent battery cells among the plurality of battery cells.

### BRIEF DESCRIPTION OF THE DRAWINGS

A more complete appreciation of embodiments of the disclosure will be readily obtained as the same becomes better understood by reference to the following detailed description when considered in connection with the accompanying drawings, which are presented solely for illustration and not limitation of the disclosure, and in which:

FIG. 1A illustrates an example metal-ion (e.g., Li-ion) battery in which the components, materials, methods, and other techniques described herein, or combinations thereof, may be applied according to various embodiments.

FIG. 1B illustrates a high-level electrical diagram of an exemplary battery module that shows P groups 1 . . . N connected in series in accordance with an embodiment of the disclosure.

FIG. 2 illustrates a battery module during assembly.

FIG. 3 illustrates the battery module of FIG. 2 during a later point of assembly after battery cells are inserted into respective receptacles of a bottom cell fixation element.

FIGS. 4-16B illustrate a battery module assembly procedure in accordance with an embodiment of the disclosure.

FIG. 17 illustrates two variants of pin arrangements in an assembly device.

FIG. 18 illustrates a coordinate system (x, y, z) for battery cell arrangements.

FIG. 19 depicts examples A-C of foil being arranged between two battery cells in adjacent cell layers and examples I-III of foil configurations in accordance with embodiments of the disclosure.

FIG. 20A illustrates a single-piece foil arrangement (foil arranged in y-direction) for the battery module in accordance with an embodiment of the disclosure.

FIG. 20B illustrates a multi-piece foil arrangement (foil arranged in y-direction) for the battery module in accordance with an embodiment of the disclosure.

FIG. 21A illustrates a single-piece foil arrangement (foil arranged in x-direction) for the battery module in accordance with an embodiment of the disclosure.

FIG. 21B illustrates a multi-piece foil arrangement (foil arranged in x-direction) for the battery module in accordance with an embodiment of the disclosure.

FIG. 22A illustrates a single-piece foil arrangement (foil arranged diagonally across x and y directions) for the battery module in accordance with an embodiment of the disclosure.

FIG. 22B illustrates a multi-piece foil arrangement (foil arranged diagonally across x and y directions) for the battery module in accordance with an embodiment of the disclosure.

### DETAILED DESCRIPTION

Embodiments of the disclosure are provided in the following description and related drawings. Alternate embodiments may be devised without departing from the scope of the disclosure. Additionally, well-known elements of the disclosure will not be described in detail or will be omitted so as not to obscure the relevant details of the disclosure.

Energy storage systems may rely upon batteries for storage of electrical power. For example, in certain conventional electric vehicle (EV) designs (e.g., fully electric vehicles, hybrid electric vehicles, etc.), a battery housing mounted into an electric vehicle houses a plurality of battery cells (e.g., which may be individually mounted into the battery housing, or alternatively may be grouped within respective battery modules that each contain a set of battery cells, with the respective battery modules being mounted into the battery housing). The battery modules in the battery housing are electrically connected (e.g., in series or in parallel) to a battery junction box (BJB) via busbars, which distribute electric power to an electric motor that drives the electric vehicle, as well as various other electrical components of the electric vehicle (e.g., a radio, a control console, a vehicle Heating, Ventilation and Air Conditioning (HVAC) system, internal lights, external lights such as head lights and brake lights, etc.).

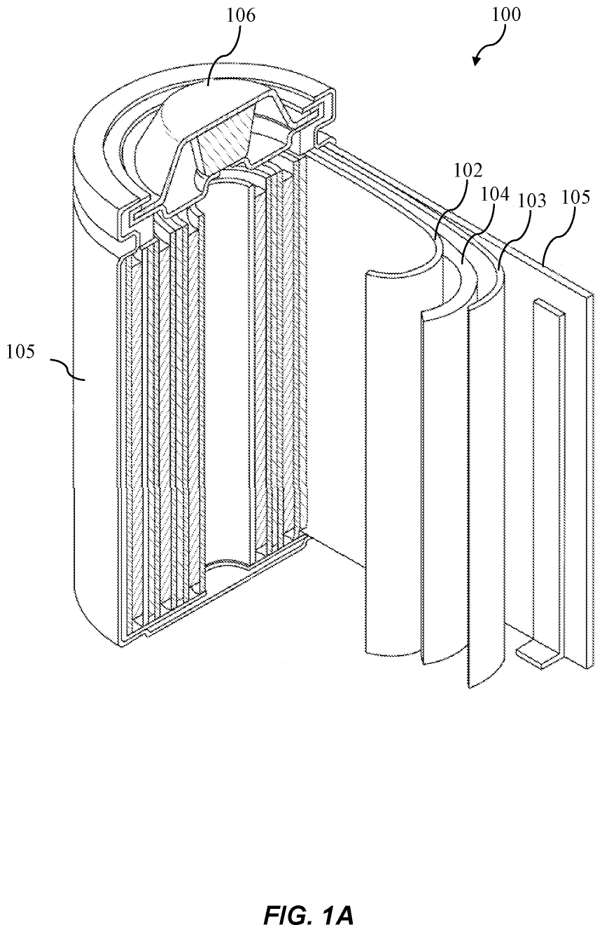

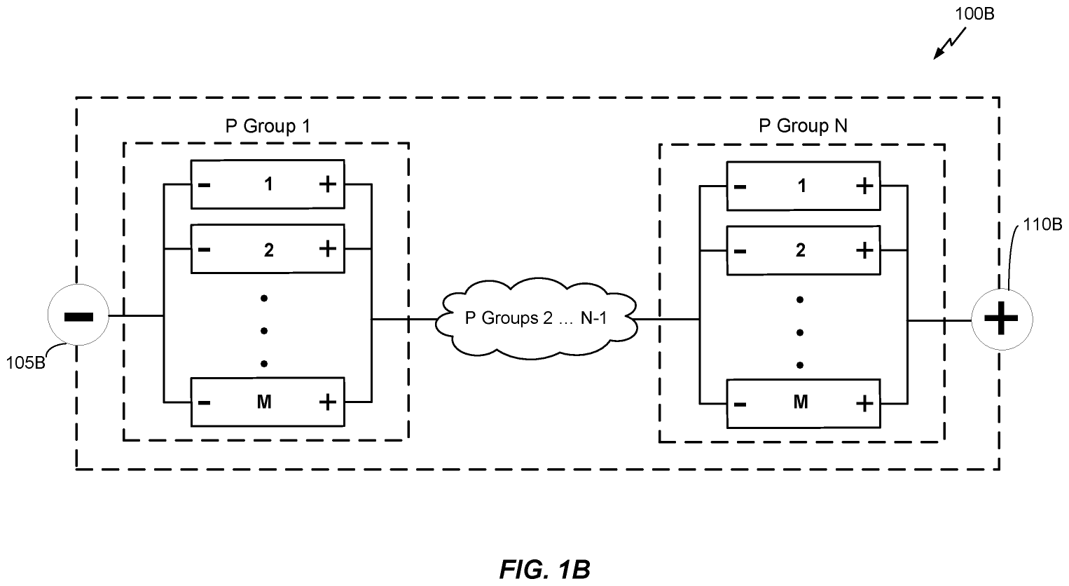

FIG. 1A illustrates an example metal-ion (e.g., Li-ion) battery in which the components, materials, methods, and other techniques described herein, or combinations thereof, may be applied according to various embodiments. A cylindrical battery cell is shown here for illustration purposes, but other types of arrangements, including prismatic or pouch (laminate-type) batteries, may also be used as desired. The example battery 100 includes a negative anode 102, a positive cathode 103, a separator 104 interposed between the anode 102 and the cathode 103, an electrolyte (shown implicitly) impregnating the separator 104, a battery case 105, and a sealing member 106 sealing the battery case 105.

Embodiments of the disclosure relate to various configurations of battery modules that may be deployed as part of an energy storage system. In an example, while not illustrated expressly, multiple battery modules in accordance with any of the embodiments described herein may be deployed with respect to an energy storage system (e.g., chained in series to provide higher voltage to the energy storage system, connected in parallel to provide higher current to the energy storage system, or a combination thereof).

FIG. 1B illustrates a high-level electrical diagram of a battery module 100B that shows P groups 1 . . . N connected in series in accordance with an embodiment of the disclosure. In an example, N may be an integer greater than or equal to 2 (e.g., if N=2, then the intervening P groups denoted as P groups 2 . . . N−1 in FIG. 1 may be omitted). Each P group includes battery cells 1 . . . M connected in parallel. The negative terminal of the first series-connected P group (or P group 1) is coupled to a negative terminal 105B of the battery module 100B, while the positive terminal of the last series-connected P group (or P group N) is connected to a positive terminal 110B of the battery module 100B. As used herein, battery modules may be characterized by the number of P groups connected in series included therein. In particular, a battery module with 2 series-connected P groups is referred to as a “2S” system, a battery module with 3 series-connected P groups is referred to as a “3 S” system, and so on.

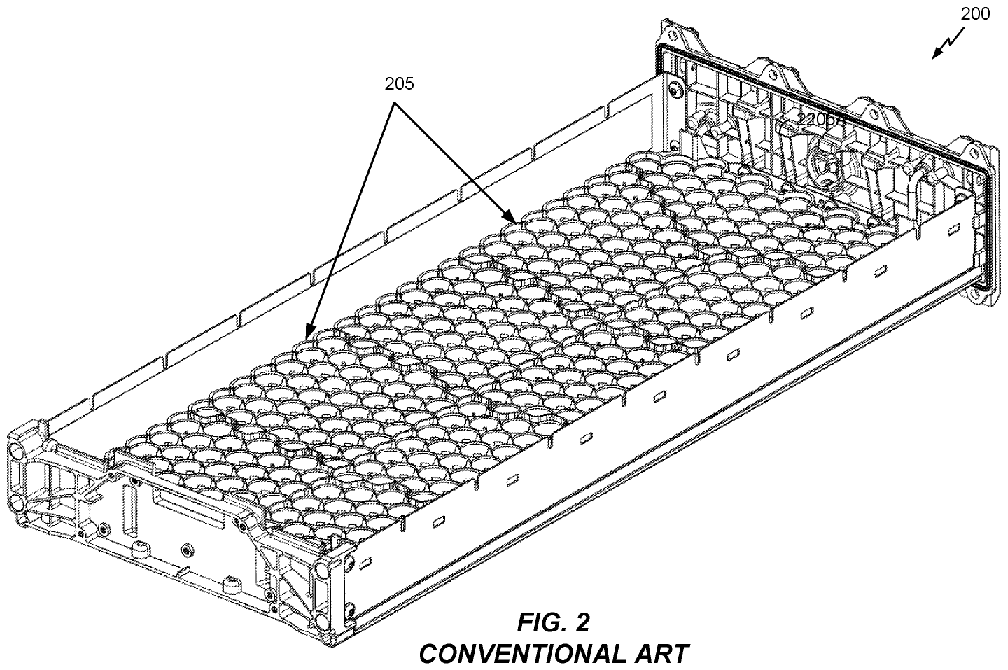

FIG. 2 illustrates a battery module 200 during assembly. In FIG. 2, a bottom cell fixation element 205 containing a plurality of battery cell receptacles for fixing a bottom part of cylindrical battery cells is shown. The bottom cell fixation element 205 may be arranged as a single large piece of plastic (or several joined pieces of plastic) that is inserted and secured (e.g., glued) to a bottom of the battery module 200. The bottom cell fixation element 205 may be arranged such that different contiguous clusters of receptacles correspond to different P Groups.

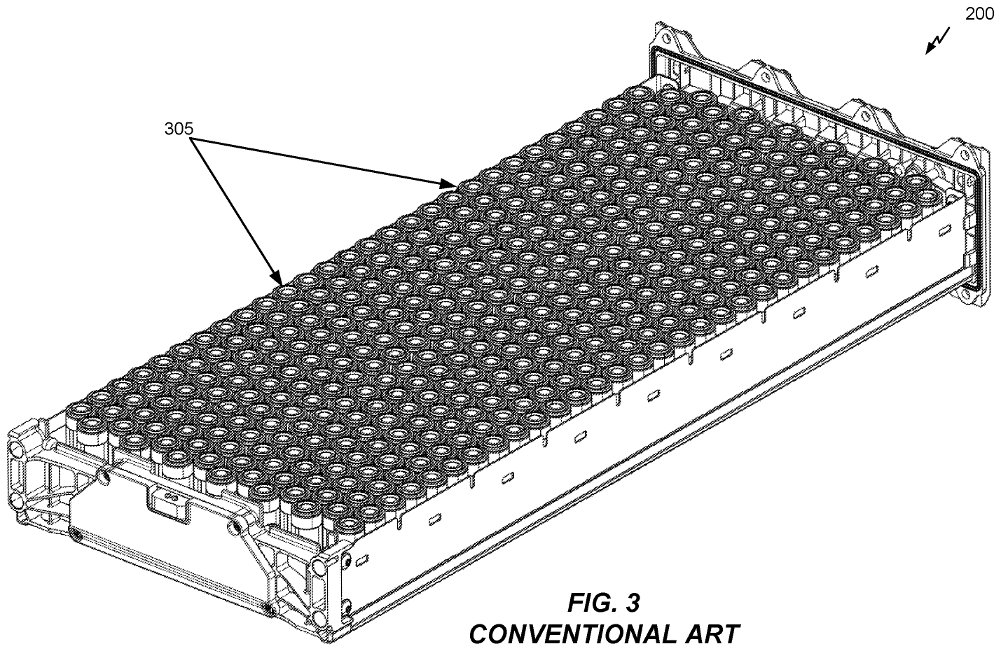

FIG. 3 illustrates the battery module 200 during a later point of assembly after battery cells 305 are inserted into the respective receptacles of the bottom cell fixation element 205. While not shown, a top cell fixation element (not shown) may be arranged over the battery cells 305, such that the battery cells 305 are substantially fixed (or secured) inside the battery module 200 via their attachment to the top cell fixation element 205 (not shown) and the bottom cell fixation element 205.

One drawback to the cell fixation arrangement depicted in FIGS. 2-3 is limited tolerance to crash forces. For example, assume that the battery module 200 is deployed in an electric vehicle that experiences crash forces. The individual battery cells 305 are securely held via the top cell fixation element 205 (not shown) and the bottom cell fixation element 205, which can cause stress and possible rupture to the battery cells 305 depending on the strength of the crash forces.

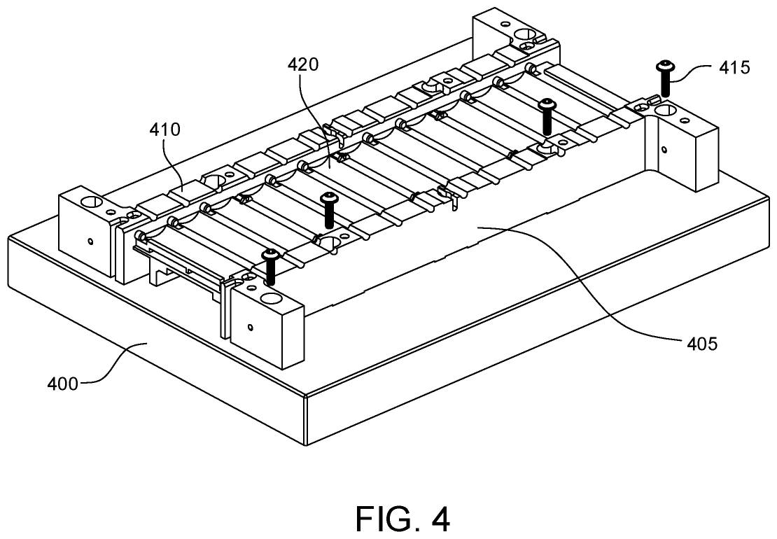

FIGS. 4-16B illustrate a battery module assembly procedure in accordance with an embodiment of the disclosure.

Referring to FIG. 4, the battery module begins construction on a base plate 400 onto which jigs 405-410 (plus side jig 405 and minus side jig 410) are mounted (e.g., via screws 415). The jigs are stackable, as will be discussed below in more detail. An external frame component 420 of the battery module is arranged between the jigs. As used herein, the “minus side” of the battery cell assembly refers to the side of the battery cell that opposes the positive terminal of the battery cell. For certain implementations, battery cells with positive and negative terminals arranged on the same side may be used (e.g., a positive cell head surrounded by a negative cell rim), in which case the “minus side” does not necessarily correspond to the negative terminal of a respective battery cell.

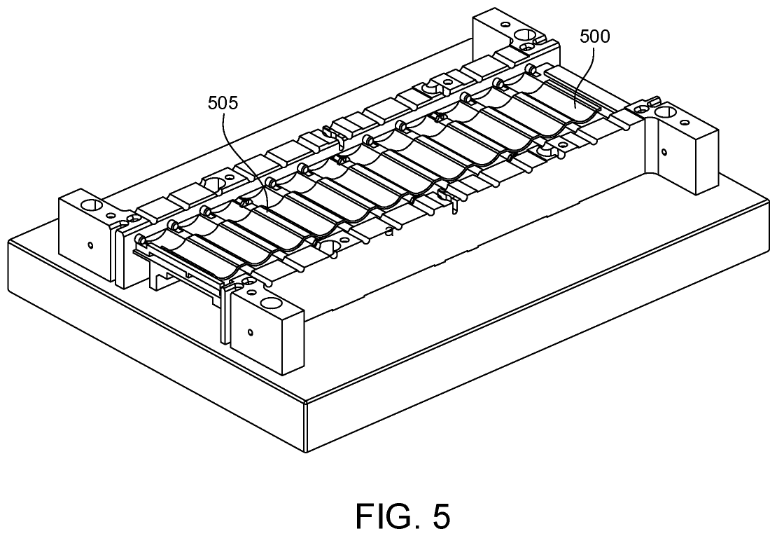

Referring to FIG. 5, an insulative layer 500 is glued onto the external frame component 420 via a dispensing machine 505.

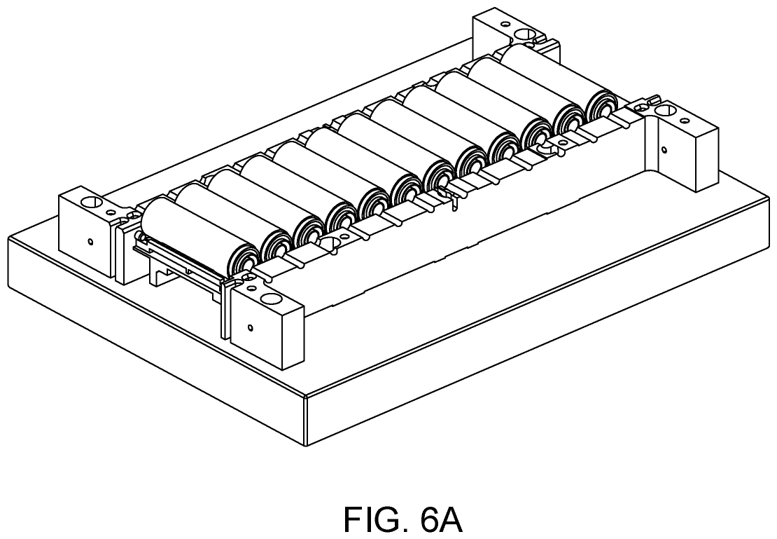

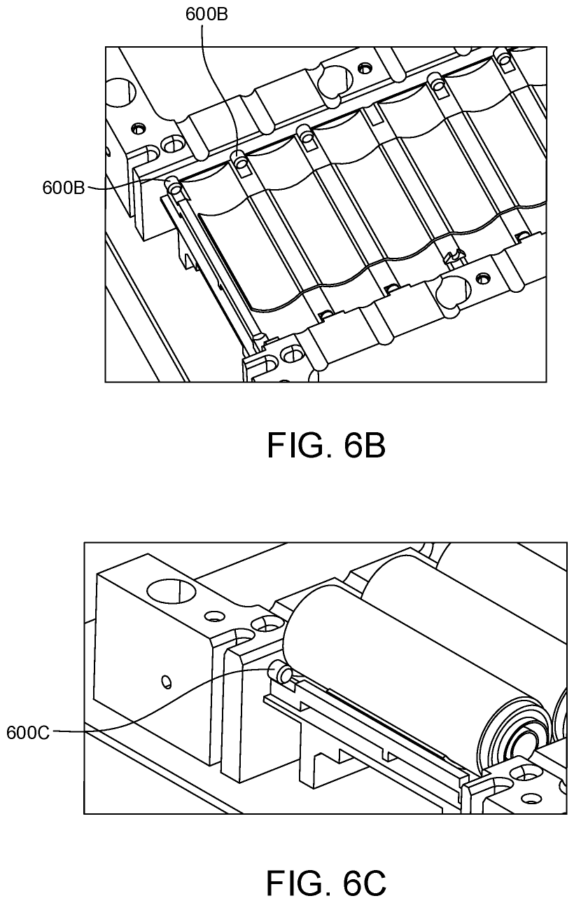

Referring to FIG. 6A, a cell layer 1 is placed onto the insulative layer. In the embodiment of FIG. 6A, the cell layer 1 includes 12 cylindrical battery cells that are each part of the same P Group. FIGS. 6B-6C demonstrate how pins 600B-600C arranged on the respective jigs can be used to fix the position of each cell in the cell layer 1. In an example, magnets may be integrated into each minus side jig to pull the respective cells of each cell layer so that the minus side of each cell layer is flush.

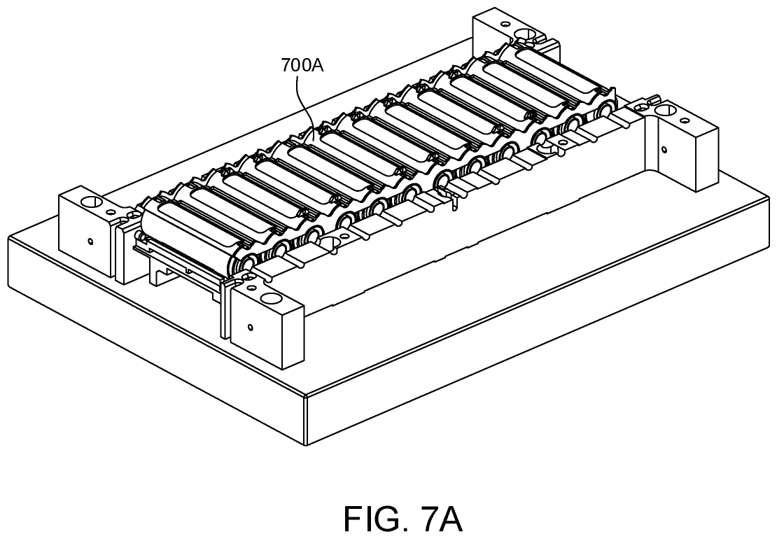

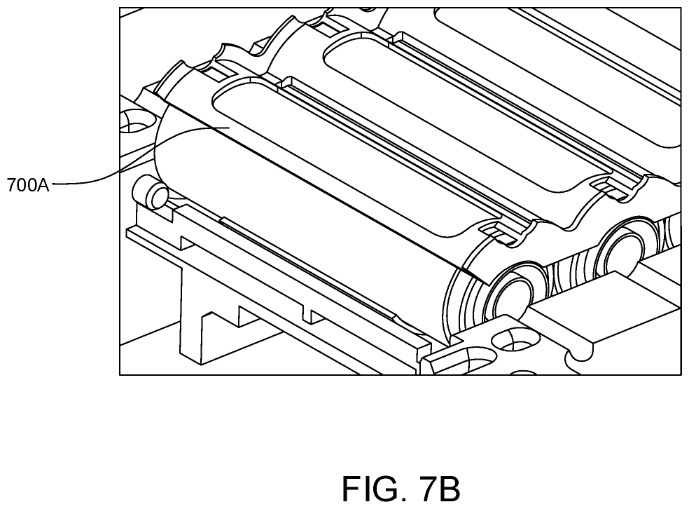

Referring to FIG. 7A, a spacer 700A is added on top of the cell layer 1. The spacer is arranged to define a spacing between the cell layer 1 and a cell layer 2 (not shown in FIG. 7A). In an example, the spacer 700A may comprise a piece or several pieces (e.g., made from plastic).

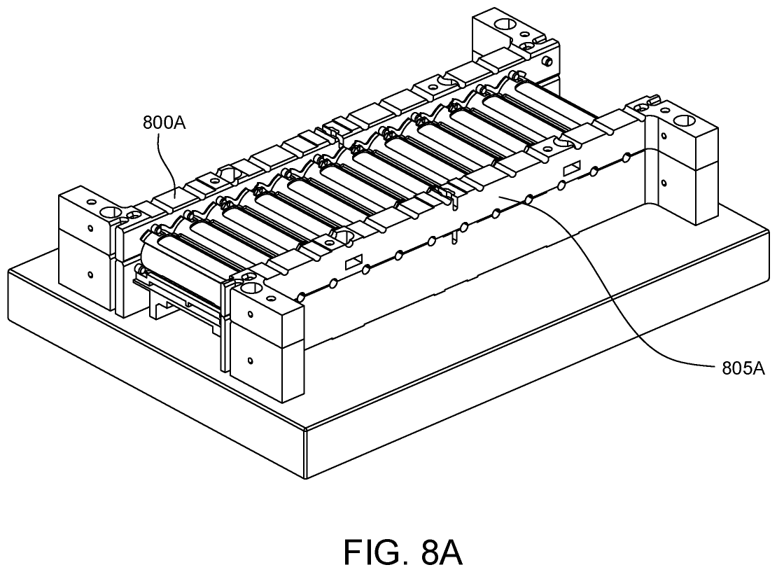

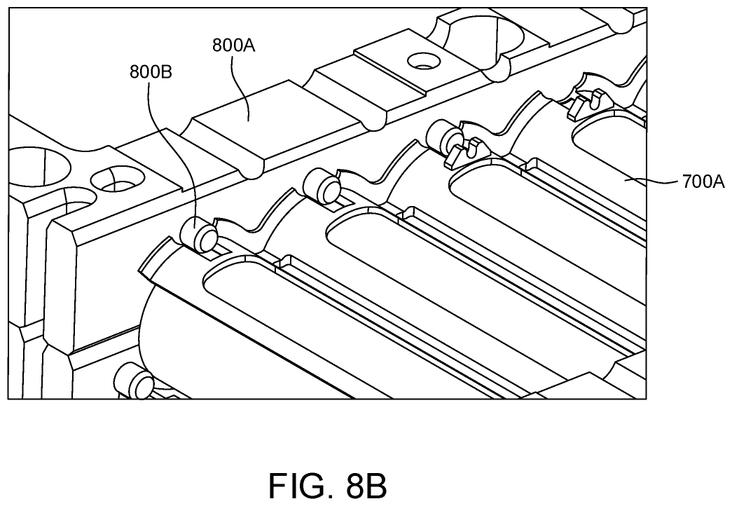

Referring to FIG. 8A, jigs 800A-805A (minus side jig 800A and plus side jig 805A) for the cell layer 2 are stacked onto the jigs 405A-410A for the cell layer 1. As shown more clearly in FIG. 8B, notches in the spacer 700A between cell layers 1 and 2 are aligned with pins 800B on the jigs for the cell layer 2.

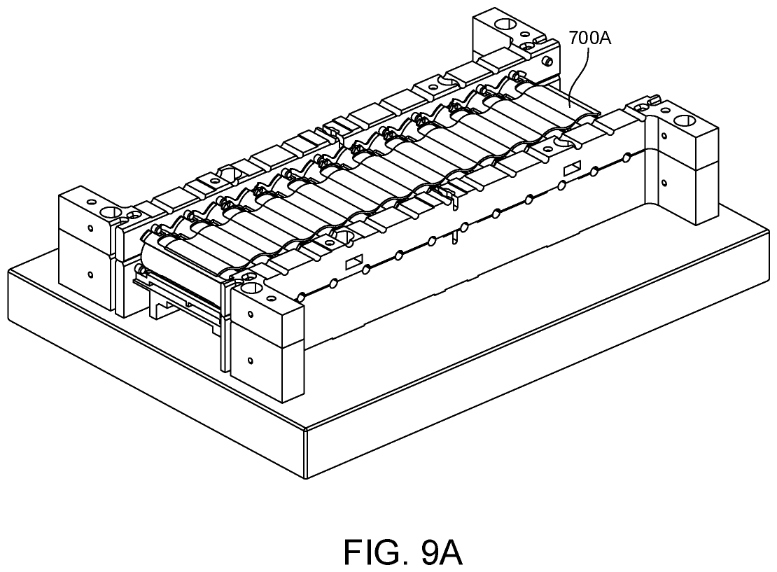

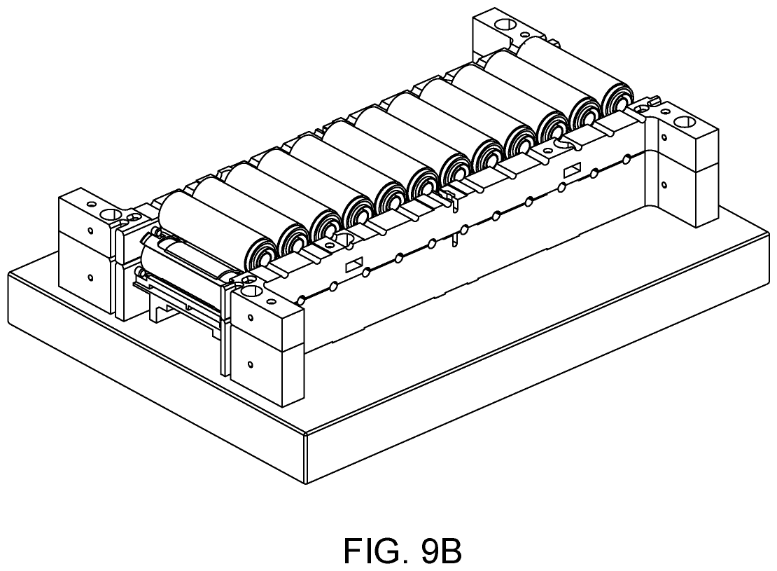

Referring to FIG. 9A, an insulative layer 900A is placed on the spacer 700A between cell layers 1 and 2. While not shown expressly in FIG. 9A, glue may be applied to the insulative layer.

Referring to FIG. 9B, the cell layer 2 is placed onto the insulative layer and secured via the glue. In the embodiment of FIG. 9B, the cell layer 2 includes 12 cylindrical battery cells that are each part of the same P Group. The P Group of cell layer 2 may be the same or different from the P Group of cell layer 3, depending on the configuration of contact plate(s) used in the battery module (described below in more detail).

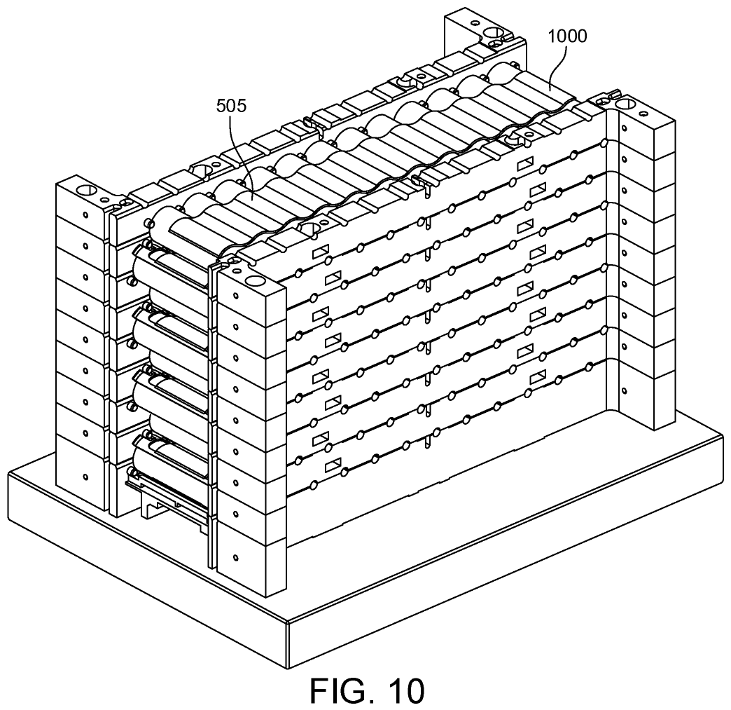

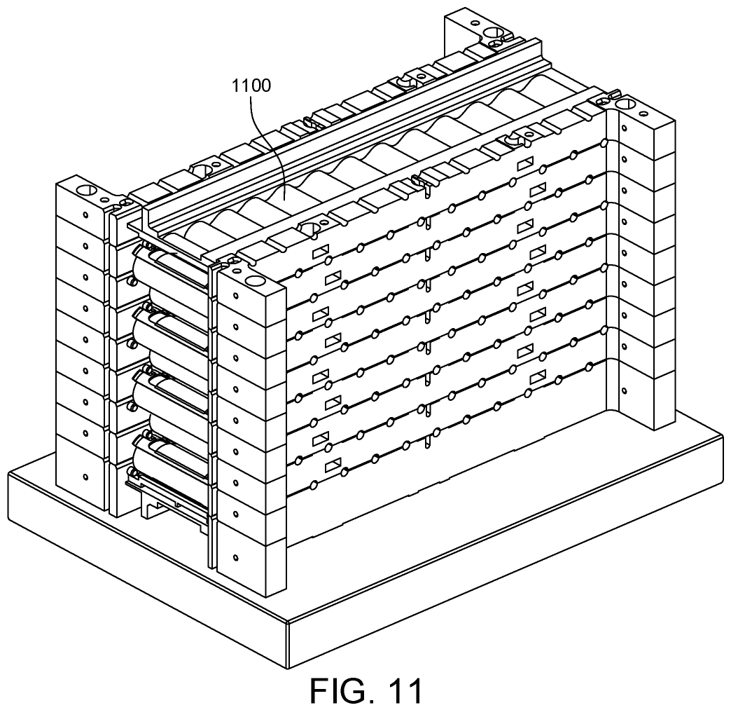

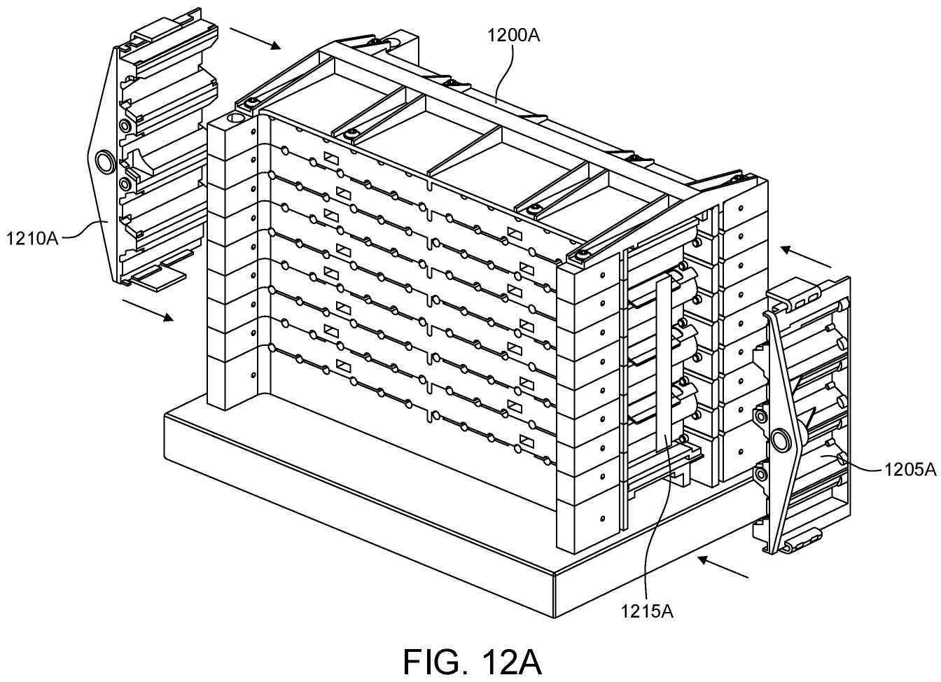

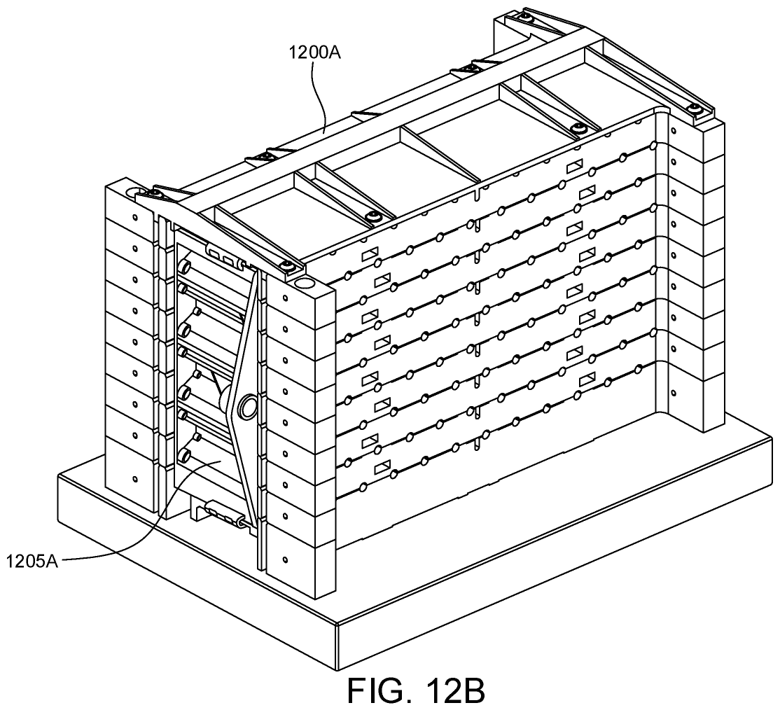

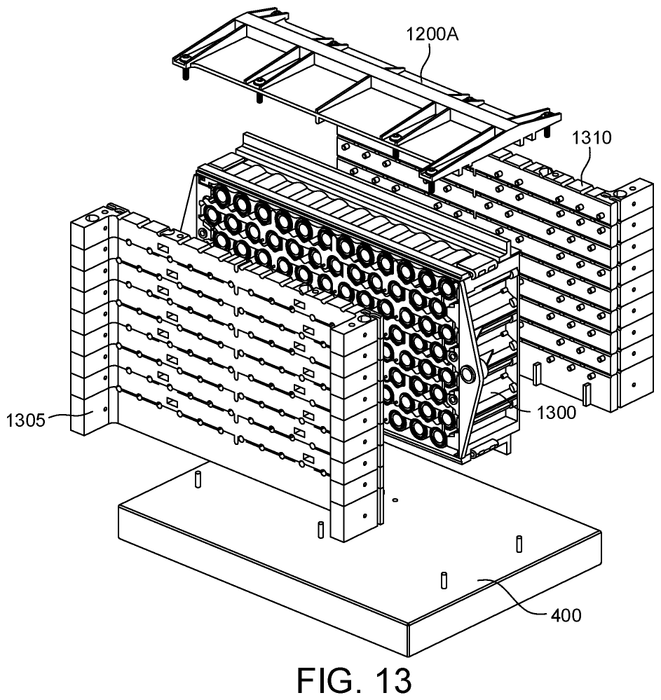

At this point, the processes depicted in FIGS. 7A-9B may repeat a given number of times until a desired number of cell layers are constructed, resulting in the arrangement depicted in FIG. 10 including cell layers 1-8. As shown in FIG. 10, glue is applied to the top-most insulative layer 1000, after which another external frame component 1100 is attached to the top-most insulative layer 1000 as shown in FIG. 11. As shown in FIGS. 12A-12B, a top jig 1200A is added, after which opposing sidewalls 1205A-1205A are attached via glue 1210A. The battery module 1300 is then separated from respective jig towers 1305-1310, top jig 1200A and the base plate 400 as shown in FIG. 13.

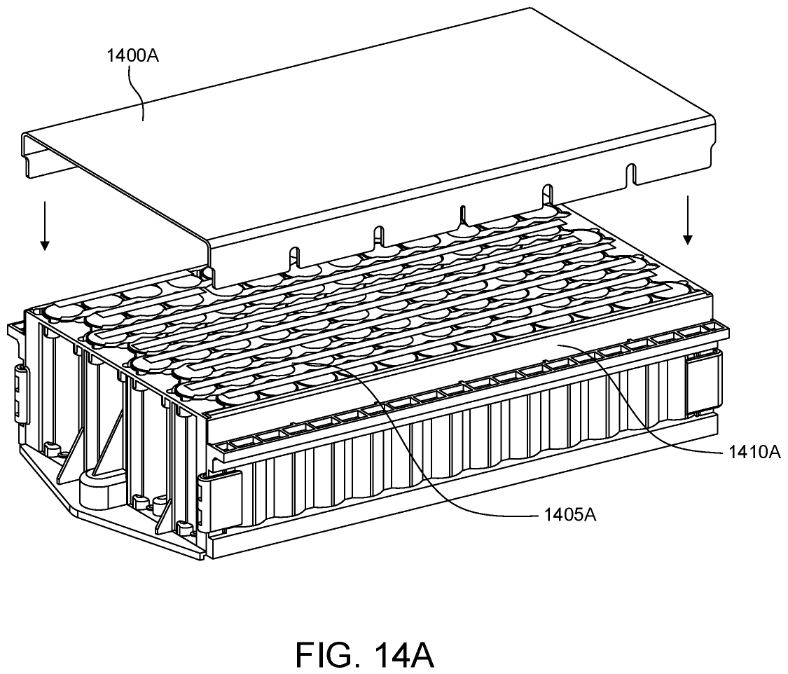

Referring to FIGS. 14A-14B, a bottom plate 1400A is secured to the battery module via glue 1405A arranged inside of respective slots 1410A.

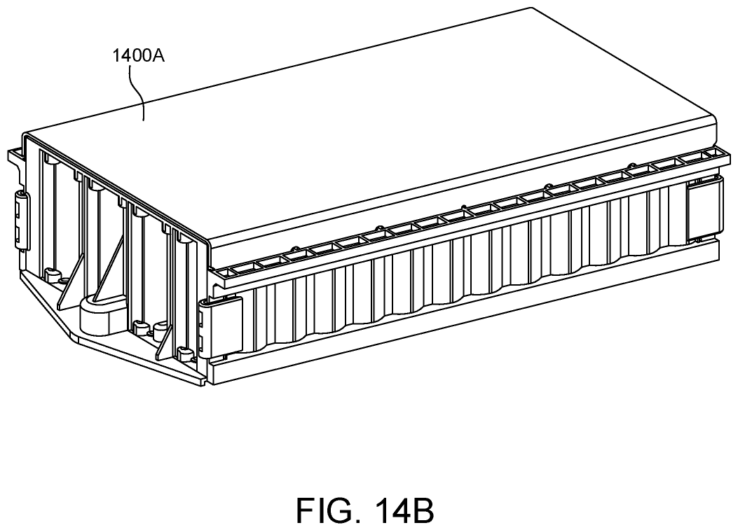

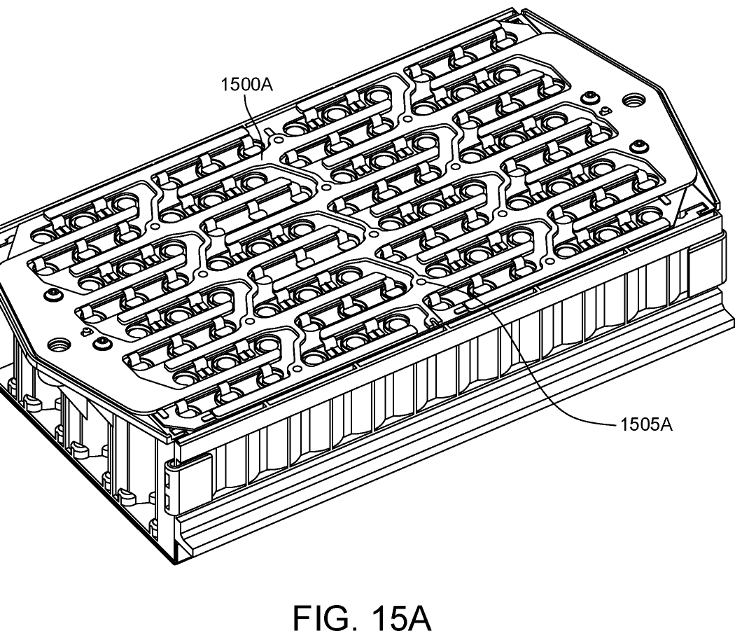

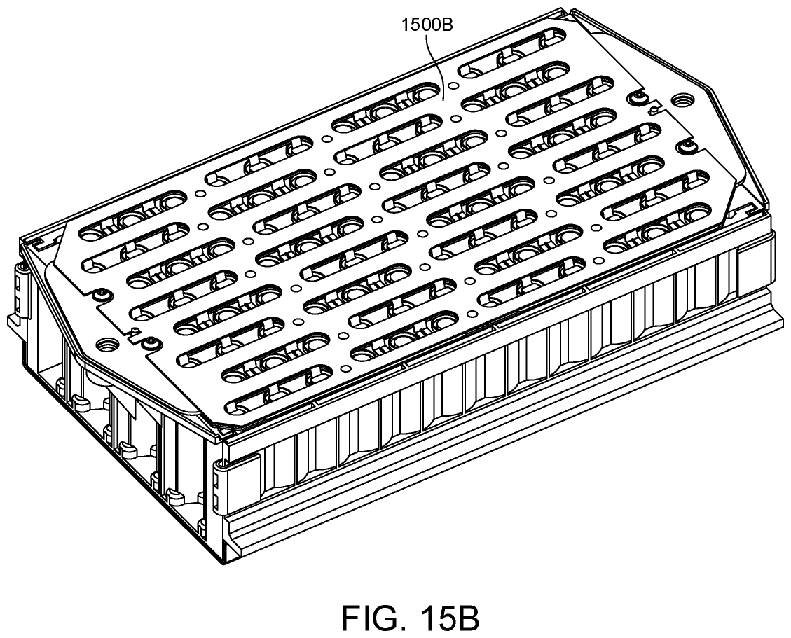

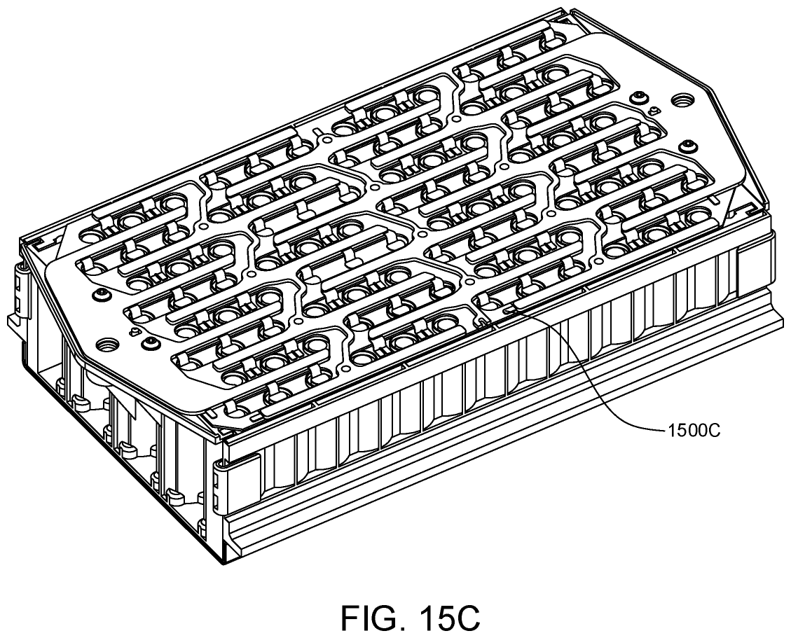

Referring to FIG. 15A, a conductive plate (or contact plate) 1500A is arranged over the battery cells (e.g., fixed with glue) of the battery module. In an example, the contact plate 1500A may be secured in place via glue 1505A. FIG. 15B depicts an alternative contact plate 1500B that comprises 2-layer foil. Examples of contact plates are described at least with respect to FIGS. 7A-8B of U.S. Patent Publication No. 2018/0108886A1, entitled “Multi-layer contact plate configured to establish electrical bonds to battery cells in a battery module”, and hereby incorporated by reference in its entirety. Referring to FIG. 15C, the contact plate of FIG. 15A may further include contact tabs 1500C onto which sensor wire may be connected (e.g., thermistors).

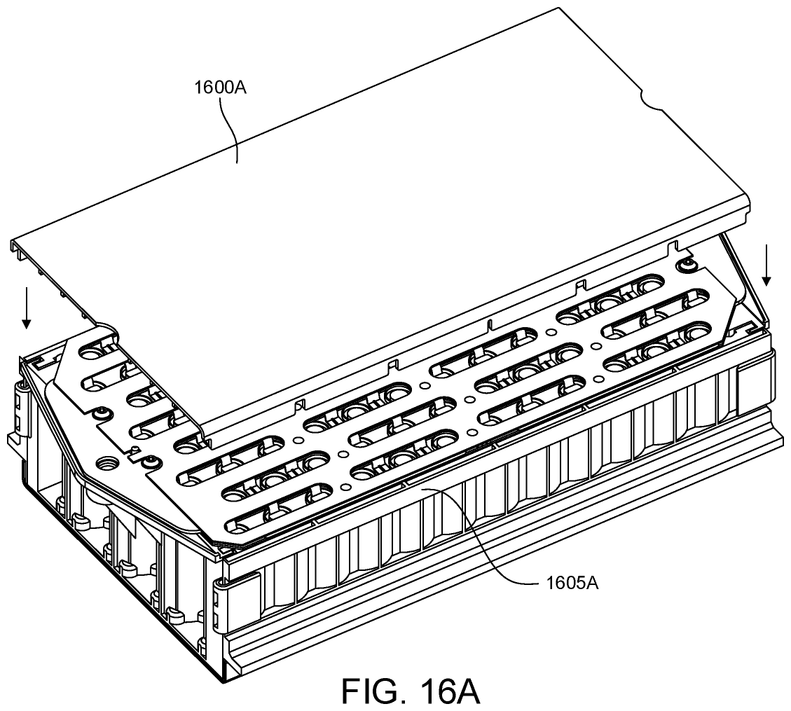

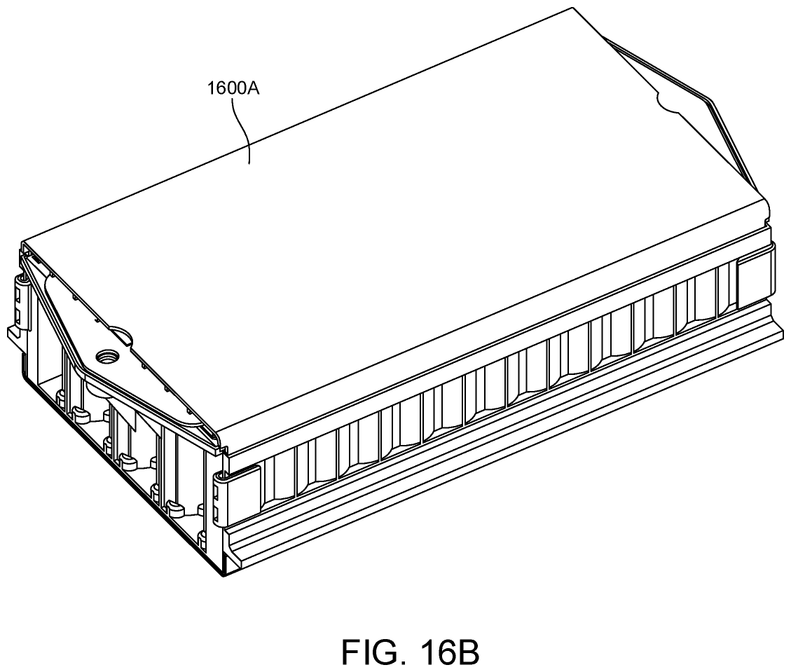

Referring to FIGS. 16A-16B, a cover (or top plate) 1600A is added to the battery module (e.g., via glue arranged within slots 1605A). At this point, the battery module is complete and may be deployed as part of an energy storage system (e.g., for an electric vehicle). The external parts of the battery module (e.g., external frame components, sidewalls, bottom plate and cover) collectively comprise a battery housing for the battery cells contained therein.

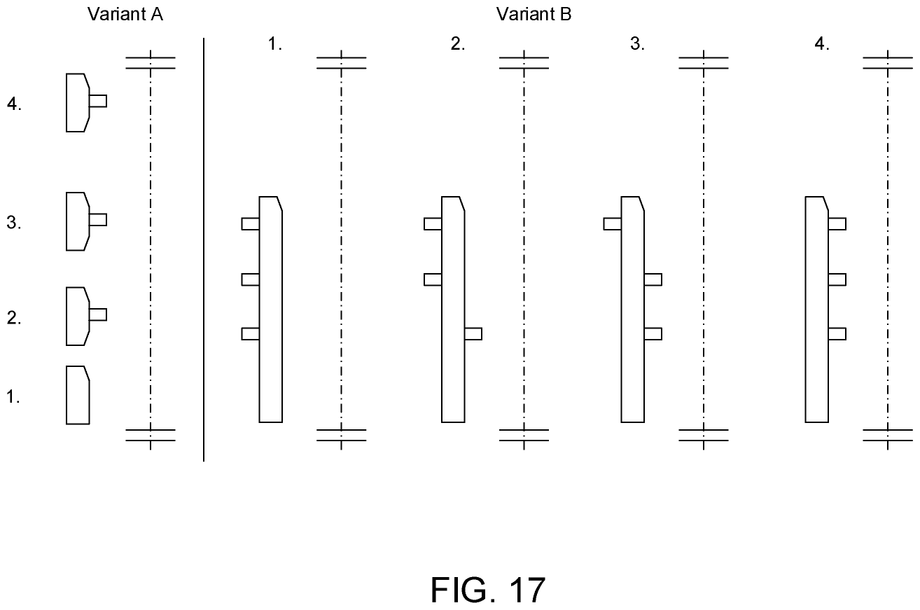

FIG. 17 illustrates two variants of pin arrangements in the assembly device (i.e., in the minus side and plus side jigs). The pins shown in FIG. 17 map to the pins that are aligned with inter-cell layer spacers, such as pins 800B being aligned with space 700A as shown in FIGS. 8A-8B.

In variant A, the pins are fixed on different jigs and are added when each new jig is added as illustrated in FIGS. 4-16B. In this case, respective jig towers successively increase in height as each new jig level is added. In variant B, a jig tower that comprises a plurality of stacked jigs and/or a single large structure (one large jig comprising multiple cell layers) is used, whereby pins can be set to a withdrawn position (not inserted) or an inserted position. In variant B(1), each pin of the jig tower is withdrawn. In variant B(2), the pin for cell layer 1 is inserted. In variant B(3), the pin for cell layers 1 and 2 are inserted. In variant B(3), the pin for cell layers 1-3 are inserted. As will be appreciated, the jig tower can span any number of cell layers, and multiple jig towers and/or individual jigs can be stacked together as well.

Referring to FIG. 18, a coordinate system (x, y, z) is defined for battery cell arrangements is defined. In an example, the battery cells depicted in FIG. 18 may correspond to a sampling of battery cells arranged in three adjacent cell layers during the process of FIGS. 4-17.

Embodiments of the disclosure are directed to arranging foil (e.g., aluminum foil) between cell layers of a battery module, such as the battery module constructed in accordance with the process of FIGS. 4-17. In some designs, this foil may be used as a positioning element to control the position of battery cells of the battery module (e.g., during gluing of the battery cells while their position is still subject to disruption, while also providing increased mechanical structural strength in case of a collision during battery operation).

In an embodiment, to improve energy density, the battery cells in the battery module may be arranged in a triangular manner with a distance of approximately the cell diameter from each cell to the adjacent cells. Foil may be inserted between the battery cells of different cell layers, and the foil may be in contact with (e.g., attached to) a foil collar at the top and/or bottom of a battery cell to fix the z-position of the battery cell. The bottom of the cell may further be in contact with a surface (e.g., the surface of the bottom plate) to fix the cell position in x and y directions. The contact between the bottom of the cell and the surface may be either direct or indirect. In an example, direct surface contact points between the bottom of the battery cell and the bottom plate can be implemented if the bottom plate is insulative, or alternatively if the bottom plate is conductive (e.g., cooling plate) with an insulative coating arranged thereon. In other designs, the cell position between the bottom of the battery cell and the bottom plate may ensure the cell position in z-direction may be defined via a clamping device that secures the battery cell in position while being glued to the bottom plate (after hardening, the glue is sufficient to hold the battery cell in position). In other designs, mechanically strong objects may be arranged between the bottom of the battery cell and the bottom plate. In some designs, these mechanically strong objects may comprise insulative beads (e.g., glass spherical beads) mixed with a thermally conductive and electrically insulative paste (e.g., the weight of the battery cells will push down on the paste but will ultimately be stopped by the insulative beads, with the diameter of the beads defining the z-direction offset between the bottom of the battery cell and the bottom plate).

In case of a collision impacting the battery module, the foil provides increased structural stiffness. Also, the foil can include defined weak points (e.g., perforations, or other types of area-specific controlled damage) such that those weak points will be the first part of the foil to rupture in case of collision. The foil may further be waved in a contact area with the battery cells to compensate tolerances. In a further embodiment, glue (or some other adhesive type) may be applied between the foil and the battery cells to further increase mechanical strength. The collar may also be used to increase a creeping path (or electrical creeping distance over which arcs may occur) between battery cells of different P Groups. In an example, the foil may comprise an electrically conductive material (e.g., aluminum, etc.), an electrically insulative material (e.g., insulative foil), or an electrically conductive material (e.g., aluminum) coated or covered with an insulative material. In some designs, the collar may be used in conjunction with the electrically insulative material insulative-coating implementations. By contrast, in some designs, if the foil comprises an uncoated electrically conductive material, the collar can be avoided such that electricity is not conducted across the foil.

In a further embodiment, a thickness of the foil is less than an original gap between the battery cells of adjacent cell layers. For example, the thickness may be in a range from about 0.01 mm to about 1.00 mm in some designs, preferably about 0.30 mm in some designs.

FIG. 19 depicts examples A-C of foil being arranged between two battery cells in adjacent cell layers and examples I-III of foil configurations in accordance with embodiments of the disclosure. Referring to FIG. 19, foil arrangement A depicts corrugated foil with a collar, foil arrangement B depicts corrugated foil with a collar and tolerance compensation waving, and foil arrangement C depicts corrugated foil with a collar and tolerance compensation waving without additional z-positioning (e.g., the foil does not envelope the top/bottom cell surface to the degree shown in foil arrangements A-B). As shown in FIG. 19, the ‘collar’ of the corrugated foil may at least partially wrap a top outer rim or bottom outer rim of a respective battery cell. Further, the corrugated foil is arranged so as to curve (or wave) in between the cylindrical curve of the respective shafts of the battery cells.

Referring to FIG. 19, foil configuration I includes top-to-bottom perforations in the shape of a dotted-line, foil configuration II includes top-to-bottom perforations in the shape of a dashed-line, and foil configuration III includes top-to-bottom perforations caused by a laser (e.g., laser-cutting). Foil configurations I-III represent examples of how weak points can be integrated the foil. So, in response to a collision or other impact to the battery module, the foil will break (or rip) first along these weak points. In each of the foil configurations I-III, the perforations (or weak points) are staggered at intervals between two ends of the foil

As noted above, the foil may be arranged between adjacent cell layers as part of the process of FIGS. 4-17. For example, at some point after a new cell layer is added to the in-progress battery module, the foil may be laid over the new cell layer (e.g., directly on the battery cells after FIGS. 6A-6C, on top of the spacer after FIGS. 7A-8B, on top of the insulative layer after FIGS. 9A-9B, and so on).

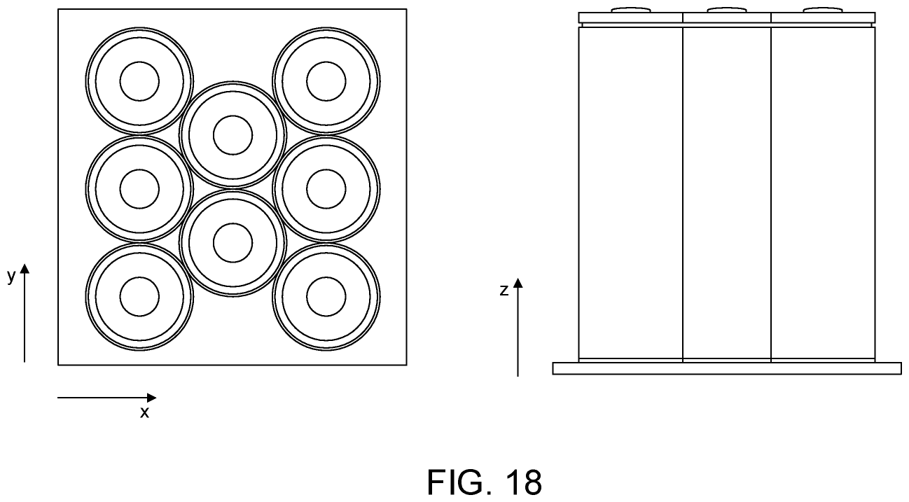

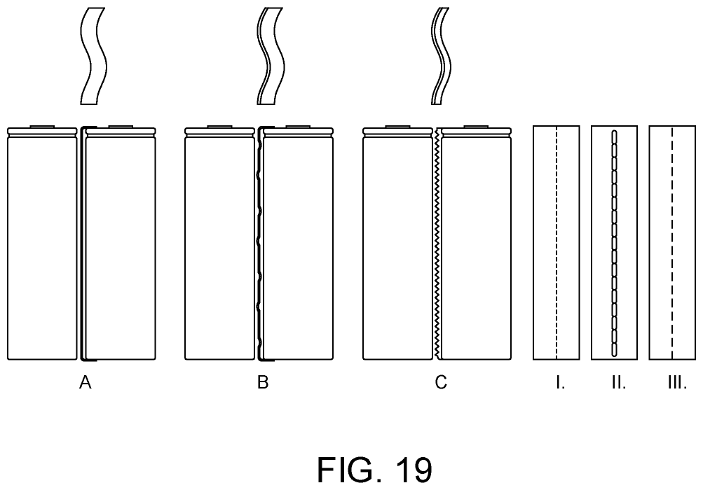

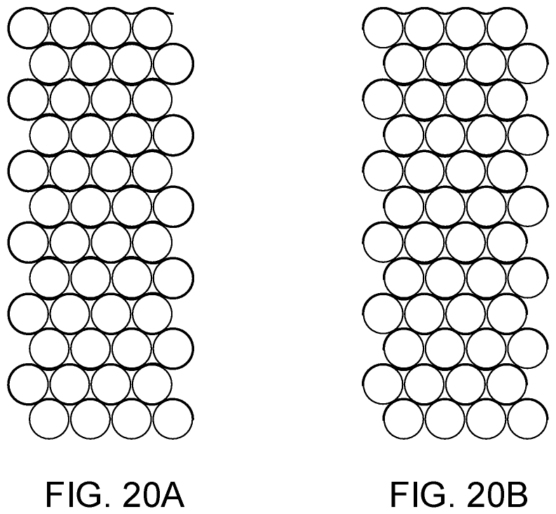

In one example, the foil in the battery module may be added as one long piece that is threaded end-to-end between one pair of adjacent cell layers and then wraps around and is threaded through a next adjacent pair of cell layers. An example of a single-piece foil arrangement for the battery module is depicted in FIG. 20A (foil arranged in y-direction). In another example, a separate piece of foil may be threaded between each pair of adjacent cell layers, as depicted in FIG. 20B (foil arranged in y-direction).

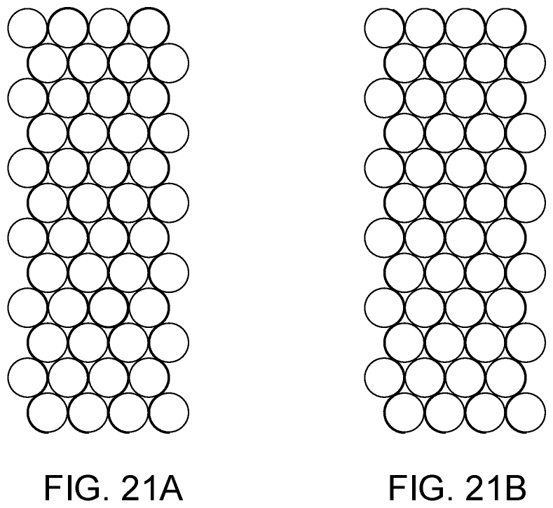

In an alternative example, the foil may be arranged end-to-end between inter-layer cell rows that are perpendicular to the cell layers described above with respect to FIGS. 14-19. In this context, the cell layers may be referred to as “columns”, while the cells arranged perpendicularly to these columns may be referred to as “rows”. An example of a single-piece foil arrangement between rows for the battery module is depicted in FIG. 21A (foil arranged in x-direction). In another example, a separate piece of foil may be threaded between each pair of adjacent rows, as depicted in FIG. 21B (foil arranged in x-direction).

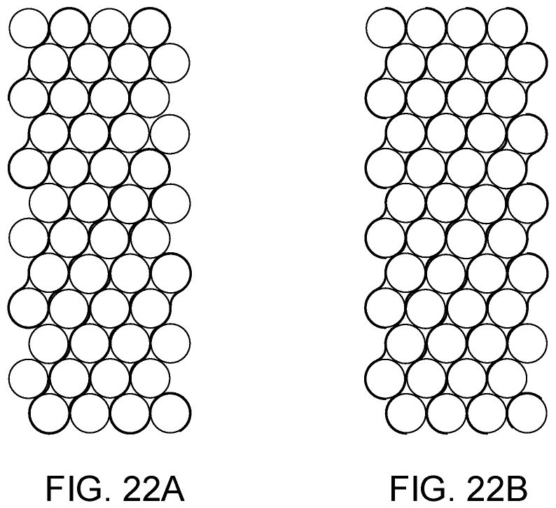

In an alternative example, the foil may be arranged diagonally (in terms of x-y direction) across different cell layers and across inter-layer cell rows. In this context, the cell layers may be referred to as “columns”, while the cells arranged perpendicularly to these columns may be referred to as “rows”. An example of a single-piece diagonal foil arrangement for the battery module is depicted in FIG. 22A. In another example, a separate piece of foil may be threaded diagonally, as depicted in FIG. 22B.

In an example, as shown in FIG. 22A, the foil is threaded end-to-end along a first diagonal path across the plurality of rows and columns, and then wraps around a battery cell along the first diagonal path and is then threaded end-to-end along a second diagonal path across the plurality of rows and columns, and so on. The arrangement in FIG. 22B is similar except that separate pieces of foil are used between each diagonal path.

While the embodiments described above relate primarily to land-based electric vehicles (e.g., cars, trucks, etc.), it will be appreciated that other embodiments can deploy the various battery-related embodiments with respect to any type of electric vehicle (e.g., boats, submarines, airplanes, helicopters, drones, spaceships, space shuttles, rockets, etc.).

While the embodiments described above relate primarily to battery module compartments and associated battery modules and insertion-side covers for deployment as part of an energy storage system for an electric vehicle, it will be appreciated that other embodiments can deploy the various battery-related embodiments with respect to any type of energy storage system. For example, besides electric vehicles, the above-noted embodiments can be applied to energy storage systems such as home energy storage systems (e.g., providing power storage for a home power system), industrial or commercial energy storage systems (e.g., providing power storage for a commercial or industrial power system), a grid energy storage system (e.g., providing power storage for a public power system, or power grid) and so on.

As will be appreciated, the placement of the various battery module compartments in the above-noted embodiments is described as being integrated into a vehicle floor of an electric vehicle. However, it will be appreciated that the general closed compartment profile design may be extended to battery module mounting areas that can be installed in other locations within the electric vehicle (e.g., in a trunk of the electric vehicle, behind one or more car seats, under a front-hood of the electric vehicle, etc.).

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range.

The forgoing description is provided to enable any person skilled in the art to make or use embodiments of the invention. It will be appreciated, however, that the invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the embodiments of the invention.

What is claimed is:

1. A battery module, comprising:
a plurality of battery cells arranged in a plurality of rows and columns; and
foil arranged between two or more adjacent battery cells among the plurality of battery cells.

2. The battery module of claim 1,
wherein the foil is attached to a top of at least one of the two or more adjacent battery cells to fix the two or more adjacent battery cells in place, a
wherein the foil is attached to a bottom of at least one of the two or more adjacent battery cells to fix the two or more adjacent battery cells in place, or
a combination thereof.

3. The battery module of claim 1,
wherein the foil comprises an electrically conductive material, or
wherein the foil comprises an electrically insulative material, or
wherein the foil comprises an electrically conductive material that is coated with an electrically insulative layer.

4. The battery module of claim 1, wherein the foil comprises one or more predefined weak points that are configured to be a first part of the foil to break in response to a collision of the battery module.

5. The battery module of claim 4, wherein the one or more predefined weak points correspond to one or more perforations defined in the foil.

6. The battery module of claim 5, wherein the one or more perforations are defined in the foil via a laser or via ripping.

7. The battery module of claim 4, wherein the one or more weak points comprise a plurality of weak points that are staggered at intervals between two ends of the foil.

8. The battery module of claim 1, further comprising:
an adhesive that attaches the foil to at least one of the two or more adjacent battery cells.

9. The battery module of claim 1, wherein a thickness of the foil is in a range from about 0.01 mm to about 1.00 mm.

10. The battery module of claim 1,
wherein the two or more adjacent battery cells correspond to two or more cylindrical battery cells, and
wherein the foil is arranged as corrugated foil that curves or waves between respective shafts of the two or more cylindrical battery cells.

11. The battery module of claim 1, wherein the foil is arranged with at least one collar that at least partially wraps around at least one outer cell rim of at least one of the two or more adjacent battery cells.

12. The battery module of claim 11,
wherein the at least one outer cell rim comprises a top outer cell rim of the at least one battery cell,
wherein the at least one outer cell rim comprises a bottom outer cell rim of the at least one battery cell, or
a combination thereof.

13. The battery module of claim 11,
wherein the foil comprises an electrically insulative material, or
wherein the foil comprises an electrically conductive material that is coated with an electrically insulative layer.

14. The battery module of claim 1, wherein the foil is threaded end-to-end between at least one pair of adjacent columns of battery cells.

15. The battery module of claim 14,
wherein the foil is threaded end-to-end between a first pair of adjacent columns of battery cells, and
wherein the foil wraps around one of the adjacent columns in the first pair and is then threaded end-to-end between a second pair of adjacent columns of battery cells.

16. The battery module of claim 1, wherein the foil is threaded end-to-end between at least one pair of adjacent rows of battery cells.

17. The battery module of claim 16,
wherein the foil is threaded end-to-end between a first pair of adjacent rows of battery cells, and
wherein the foil wraps around one of the adjacent rows in the first pair and is then threaded end-to-end between a second pair of adjacent rows of battery cells.

18. The battery module of claim 1, wherein the foil is threaded end-to-end diagonally across the plurality of rows and columns.

19. The battery module of claim 18,
wherein the foil is threaded end-to-end along a first diagonal path across the plurality of rows and columns, and
wherein the foil wraps around a battery cell along the first diagonal path and is then threaded end-to-end along a second diagonal path across the plurality of rows and columns.

20. The battery module of claim 1,
wherein the foil includes a single piece of foil, or
wherein the foil includes a plurality of separate pieces of foil.
